(19) United States
(12) Patent Application Publication
(10) Pub. No.: US 2006/0289842 A1
(43) Pub. Date: Dec. 28, 2006

(54) Conductive composition and method of using the same

(76) Inventors: Hugh P Craig, Buffo, MI (US); Derril L. Steele, Cheyenne, WY (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/545,986

(22) PCT Filed: Sep. 18, 2003
(86) PCT No.: PCT/US03/29782

§ 371 Date: Sep. 13, 2006

Related U.S. Application Data
(63) Continuation-in-part of application No. 10/392,426, filed on Mar. 18, 2003, now abandoned.
Application No. 10/392,426 is a continuation-in-part of application No. 10/392,425, filed on Mar. 18, 2003, now abandoned.

(51) Int. Cl. H01B 1/22

(52) U.S. Cl. 252/514

(57) ABSTRACT

A conductive composition includes a conductive metal, a first resin component, and a second resin component, which is an isocyanate component, that is reactive with the first resin component. A metal oxide and a lubricant are present as impurities on a surface of the metal. The second resin component is blocked at a first temperature and unblocked at a second temperature greater than the first temperature to produce fist and second fluxing agents. The first fluxing agent reacts with the lubricant to partially remove the oxide and the lubricant from the surface of the metal. The removal, or cleansing, of the oxide and the lubricant from the metal increases a conductivity of the composition. A method deposits a trace of the composition on a substrate and heats the composition to the second temperature to cause the second resin component to unblock.

### BACKGROUND OF THE INVENTION

1. Field of the Invention

The subject invention generally relates to a conductive composition and a method of using the conductive composition. More specifically, the subject invention relates to a conductive composition that is used, among other purposes, to deposit a conductive metal trace on a printed circuit board (PCB), to join electrical and electronic components into a circuit, and to attach dies to lead frames in preparation of electrical and electronic components.

2. Description of the Related Art

Conductive compositions, also referred to in the art as conductive inks, are known in the art. Methods of using the conductive compositions are also known in the art. For example, conductive compositions are used to form a conductive metal trace on a substrate, such as a PCB. For conductivity, the conductive compositions include conductive metal particles. Typically, these particles are in the form of powders or flakes. As one example of a conductive metal particle, silver flakes are excellent conductors that are preferred for use in conductive compositions because the silver flakes possess a greater extent of surface area per unit weight, which helps to ensure that the silver flakes within a particular conductive metal trace make contact with one another to form a continuous conductive silver metal “pathway”.

Silver flakes are susceptible to various factors that negatively impact their conductivity. One such factor relates to the production of the silver flakes. Silver flakes are produced by milling silver powder in the presence of a lubricant, such as stearic acid. During production of the silver flakes, the stearic acid lubricant, within which the silver powder is milled into silver flakes, is removed with a solvent. However, before the stearic acid can be removed, it reacts with a surface of the silver flakes, to form a salt of the lubricant, specifically silver stearate, and the solvent is unable to remove the silver stearate. The silver stearate is an impurity that remains on the silver flakes and negatively impacts the conductivity of the silver flakes because, although the silver stearate is conductive, it is far less conductive than pure, i.e., un-oxidized and un-lubricated, silver.

Another factor that negatively impacts the conductivity of silver flakes is that silver flakes are subject to oxidation in air, which forms silver oxide on the surface of the silver flakes. Silver oxide is another form of an impurity that remains on the silver flakes. The silver flakes are subject to oxidation as soon as they are milled and even after they are incorporated into the conductive composition. Like silver stearate, although the silver oxide is conductive, it is far less conductive than pure silver. The conductivity of prior art conductive compositions having silver flakes with the impurities of silver oxide and silver stearate still present on the surface can generally be understood by an understanding that such conductive compositions have a resistivity on the order of 20 to 50 milliohms per square.

Finally, it should also be understood that heating the conductive compositions of the prior art does not beneficially affect the conductivity of the conductive composition, either during heating or afterward Simply stated, heating does not have an effect on the conductivity of the prior art conductive compositions. Furthermore, the conductive compositions of the prior art that require a cure rely on heating by conventional furnaces or ovens at very high temperatures. These high temperatures frequently damage, i.e., melt, the substrate, such as the PCB, which are commonly made from inexpensive and non-resilient forms of plastic material, such as polystyrene.

Due to the deficiencies of the conductive compositions of the prior art, including those described above relating to the impurities of silver stearate and silver oxide, it would be desirable to provide a conductive composition that has improved conductivity due to the pure condition of the conductive metal particles. It would also be desirable to provide a method of using the conductive composition.

### SUMMARY OF THE INVENTION AND ADVANTAGES

A conductive composition includes a conductive metal, an isocyanate component, and a resin component that is reactive with the isocyanate component. In one embodiment, the conductive metal is present in an amount of from 40 to 95 parts by weight, the isocyanate component is present in an amount of from 2 to 20 parts by weight, and the resin component is present in an amount of from 1 to 20 parts by weight, wherein all parts by weight are based on 100 parts by weight of the conductive composition.

In another embodiment, the conductive metal has a surface and a metal oxide and a lubricant are present on this surface, and the conductive composition includes a first resin component and a second resin component that is reactive with the first resin component. The second resin component is blocked at a first temperature and unblocked at a second temperature that is greater than the first temperature. Upon unblocking, the second resin component produces a first fluxing agent and a second fluxing agent. The first fluxing agent reacts with at least the metal oxide and the second fluxing agent reacts with at least the lubricant. These reactions at least partially remove the metal oxide and the lubricant from the surface of the conductive metal thereby increasing a conductivity of the conductive composition.

The method of using this conductive composition includes the steps of depositing a trace of the conductive composition on a substrate and heating the conductive composition to at least the second temperature to cause the second resin component to unblock. Upon unblocking, the first and second resin components react to cure and the first and second fluxing agents are produced. The first and second fluxing agents remove the metal oxide and the lubricant from the surface of the conductive metal thereby increasing the conductivity of the trace of the conductive composition. The heating of the conductive composition according to the present invention does not damage the substrate.

The removal of the metal oxide and the lubricant from the surface of the conductive metal with the first and second fluxing agents may also be referred to as cleaning or cleansing the conductive metal by fluxing. Cleaning the conductive metal by fluxing while the conductive composition is heated to at least the second temperature, renders the conductive metal so clean that, assuming the conductive metal is silver in the form of a flake, the silver flakes are closer in proximity and contacting, possibly even coming together by a process referred to as “cold welding of a noble metal” where the silver flakes may weld and joint together. A conductive metal trace is formed and this conductive metal trace has remarkably improved conductivity as compared to conductive metal traces formed from conductive compositions that include silver flakes with silver oxides and/or lubricants still significantly present on the silver lakes. For instance, the conductive composition of the subject invention has an mproved conductivity on the order of two to ten times better than the conductivity of the conductive compositions that still have significant amounts of silver oxides and/or lubricants present on the surface of the silver flakes. As a specific example of this improved conductivity, the resistivity of the conductive compositions of the subject invention are generally on the order of 3 to 10 milliohms per square.

The heating of the conductive composition of the subject invention beneficially affects the conductivity of the conductive composition because the heating causes dissociation of the second resin component, which is blocked at the first temperature, to produce the first and second fluxing agents which react, or flux, with the metal oxide and the lubricant on the surface of the conductive metal as described above.

Accordingly, the subject invention provides a conductive composition that has improved conductivity due to the pure condition of the conductive metal particles. As such, the conductivity of the traces formed from the conductive composition of the subject invention is improved because these traces establish conductive paths that do not pass through any lubricant, such as stearic acid, any oxide, such as silver oxide, or any reactive produce of the lubricant and the silver flake, such as silver stearate. The subject invention also provides a method of using the conductive composition.

### BRIEF DESCRIPTION OF THE DRAWINGS

Other advantages of the present invention will be readily appreciated as the same becomes better understood by reference to the following detailed description when considered in connection with the accompanying drawings, which are for the purpose of illustration only and not to limit the scope of the invention in any way, wherein:

FIG. 1A is a perspective view of a conductive composition according to the subject invention deposited on a substrate, specifically a PCB, to form a conductive metal trace;

FIG. 1B is a side view of the conductive metal trace;

FIG. 2A is a side view of the conductive metal trace and, therefore, the conductive composition in an un-sintered form such that conductive metal particles in the composition and trace are generally non-continuous and spaced from one another;

FIG. 2B is an enlarged side view of FIG. 2A focusing on the spacing of the conductive metal particles;

FIG. 3A is a side view illustrating the conductive metal trace and the conductive composition of FIG. 2A after application of microwave radiation for heating where the conductive metal particles are in contact with one another and fused to form a continuous, conductive metal pathway;

FIG. 3B is an enlarged side view of FIG. 3A focusing on the connection and fusing of the conductive metal particles to form the continuous, conductive metal pathway;

FIG. 4 is a perspective view illustrating a preferred use of the conductive composition as a die attachment adhesive in the preparation of electrical and electronic components; and

FIG. 5 is a side view illustrating another preferred use of the conductive composition to connect an electronic component die to lead frames.

### DETAILED DESCRIPTION OF THE INVENTION

The following description is of the best mode presently contemplated for the carrying out of the invention. This description is made for the purpose of illustrating general principles of the invention and is not to be taken in a limiting sense. The scope of the invention is best determined by reference to the appended claims.

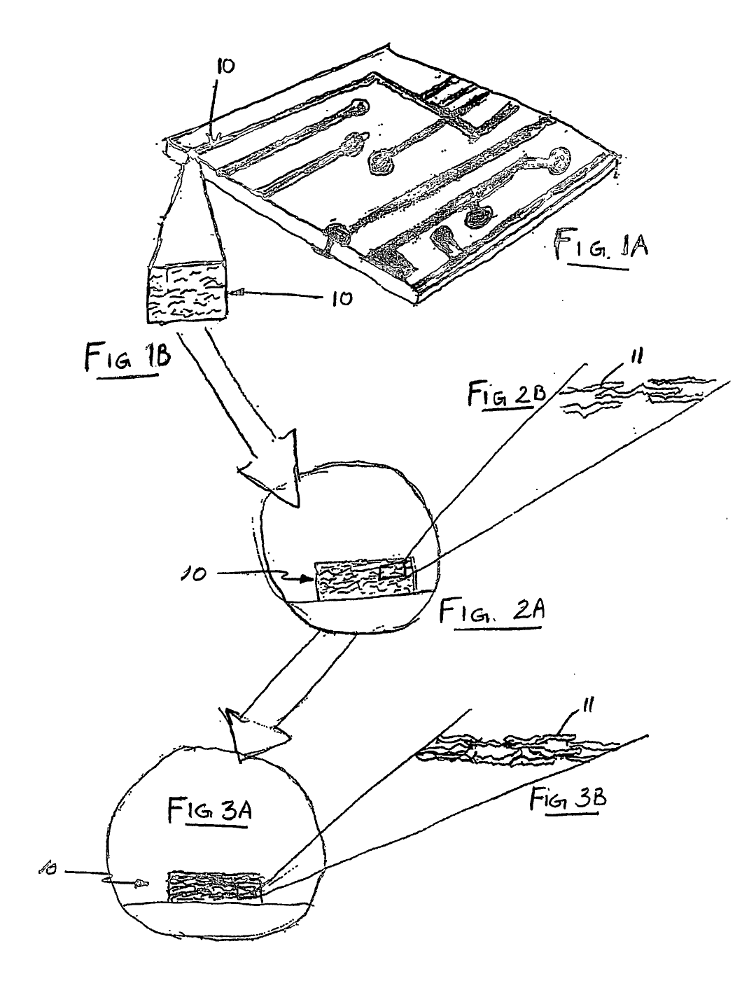

The subject invention discloses a conductive composition and a method of using the conductive composition. Referring particularly to FIGS. 1A and 1B, the conductive composition is typically applied to a substrate, preferably a non-conductive substrate such as a PCB, to form a conductive trace 10. PCBs may, in particular, be made of a low melting temperature plastic, such as polystyrene, which is not ideal for placement in a conventional furnace or oven. It is to be understood that the conductive trace 10 can be deposited on a wide variety of substrates. In other words, the substrate can be any type of substrate from the PCB to even a layer of another composition, such as a solder or adhesive composition.

In one embodiment, the conductive composition includes a conductive metal, an isocyanate component, and a resin component that is reactive with the isocyanate component. The conductive metal, which is typically a conductive metal particle, is present in an amount of from 40 to 95, preferably from 60 to 95, parts by weight. The erminology ‘particle’ as utilized herein is intended to include conductive metal powders, conductive metal flakes, and the like.

Preferably, the conductive metal is selected from the group consisting of copper, silver, aluminum, gold, platinum, palladium, beryllium, rhodium, nickel, zinc, cobalt, iron, molybdenum, iridium, rhenium, mercury, ruthenium, osmium, and 5 combinations thereof. More preferably, the conductive metal comprises a noble metal. In the most preferred embodiment of the subject invention, the noble metal is silver in particle, specifically flake 11, form. One silver flake 11 suitable for use in the conductive composition of the present invention is Silver Flake 52 which is commercially available from FerroMet. For descriptive purposes only, the remaining description will be in terms of the silver flake 11 or flakes 11 as the conductive metal. This form of description is for convenience and is not to be interpreted as limiting.

The conductive metal has a surface on which is present a metal oxide and a lubricant. In terms of the silver flakes 11, each flake 11 has a surface and the metal oxide is typically silver oxide and the lubricant is typically silver stearate. As described above, the silver stearate forms when stearic acid, which is used during the milling of the silver flakes 11 from silver powder, reacts with the surface of the silver flakes 11. As a result, for purposes of the present invention, the terminology ‘lubricant’ as utilized herein generally refers to the silver stearate, but also to any stearic acid that remains from the milling of silver powder into silver flake 11.

The isocyanate component is present in an amount of from 2 to 20, preferably from 4 to 12, parts by weight. Although the isocyanate component may initially include an unblocked isocyanate component, it preferably includes a blocked isocyanate. The most preferred blocked isocyanate is blocked hexamethylene diisocyanate, but other isocyanates including, but not limited to, diphenylmethane diisocyanate, toluene diisocyanate, and the like. The isocyanate component may even include an isocyanate-pre-polymer, which is generally the reaction product of an isocyanate and a polymer, such as a polyol.

The blocked isocyanate is blocked with a blocking agent. This blocking agent is selected from the group consisting of e-caprolactam (ECAP), methyl-ethyl ketoxime (MEKO), di-ethyl malonate (DEM), di-methyl pyrazole (DMP), and combinations thereof. Various blocked isocyanates suitable for incorporation into the conductive composition include, but are not limited to, Bayhydur BL 116, which is commercially available from Bayer Corporation of Pittsburgh, Pa., and Trixene® BI 7950, Trixene® BI 7962, and Trixene® BI 7990, which are all commercially available from Baxenden Chemicals Limited of Lancashire, England. Trixene® BI 7950 is blocked with DMP as the blocking agent, Trixene® BI 7962 is blocked with DEM as the blocking agent, and Trixene® BI 7990 is blocked with a blend of DMP and DEM as the blocking agent.

Generally, the isocyanate component is reactive with the metal oxide and the lubricant to at least partially remove the metal oxide and the lubricant from the surface of the conductive metal thereby increasing a conductivity of the conductive composition. The terminology ‘reactive with’ as utilized herein means to react with or simply to clean, cleanse, or otherwise remove some amount of the metal oxide and the lubricant from the surface of the conductive metal. In the context of the most preferred embodiment where the isocyanate includes a blocked isocyanate, the blocked isocyanate becomes unblocked, or liberates, at temperatures of from 80 to 250° C., i.e., when the conductive composition is heated. The heating of the conductive composition is described additionally below. The precise temperature at which the blocked isocyanate unblocks may vary depending on the particular blocking agent that is selected.

Once unblocked, an unblocked isocyanate and a free blocking agent are formed. The unblocked isocyanate and the free blocking agent are reactive with the metal oxide, specifically the silver oxide, and with the lubricant, specifically the silver stearate and/or stearic acid, to at least partially remove the metal oxide and the lubricant from the surface of the conductive metal, specifically the silver flake 11. Removal of the metal oxide and the lubricant from the surface of the silver flake 11 increases a conductivity of the conductive composition because pure, i.e., un-oxidized and un-lubricated, silver is more conductive than silver flakes 11 that carry impurities such as silver oxide and silver stearate.

The resin component, which is reactive with the isocyanate component, is present in an amount of from 1 to 20, preferably from 2 to 10, parts by weight. In one embodiment, the resin component includes a hydroxy-functional resin that reacts with the isocyanate component to form a polyurethane upon cure. This polyurethane is typically a non-foamed polyurethane. The most preferred hydroxy-functional resin is a phenoxy resin, which typically is a reaction product of bisphenol A and epichlorohydrin. On such phenoxy resin is commercially available from InChem Corp. of Rock Hill, S.C. as PKHP-200 Solid Grade Phenoxy Resin. In this embodiment, a ratio of NCO functional groups in the isocyanate component to OH function groups is the hydroxy-functional resin is from 1:1 to 1:2. In another embodiment, the resin component includes an amine-functional resin that reacts with the isocyanate component to form a polyurea upon cure.

The conductive composition optionally includes a solvent for application of the conductive composition. As such, it is ideal if the solvent is sufficient in type and in amount to dissolve the isocyanate component and the resin component into solution. If included in the conductive composition, the solvent is present in an amount of from 5 to 20, preferably from 6 to 12, parts by weight for dissolving the isocyanate component and the resin component. Preferably, the type of solvent is selected from the group consisting of ethylene glycol monobutyl ether, diethylene glycol monobutyl ether, and combinations thereof. Ethylene glycol monobutyl ether is commercially available as butyl Cellosolve and diethylene glycol monobutyl ether is commercially available as butyl Carbitol, both from Dow Chemical of Midland, Mich. Of course, it is to be understood that other solvents may be suitable for incorporation into the conductive composition.

In a separate embodiment, one that is preferred for optimum application of the conductive composition, the conductive composition consists essentially of the conductive metal, the isocyanate component, the resin component that is reactive with the isocyanate component, and the solvent for dissolving the isocyanate and resin components. In this particular embodiment, the conductive composition is present in an amount of from 40 to 95 parts by weight, the isocyanate component is present in an amount of from 2 to 20 parts by weight, the resin component is present in an amount of from 1 to 20 parts by weight, and the solvent is present in an amount of from 5 to 20 parts by weight. As with the embodiment set forth above, the isocyanate component is reactive with the metal oxide and the lubricant that are present on the surface of the conductive to at least partially remove the metal oxide and the lubricant from the surface of the conductive metal. As such, the conductivity of the conductive composition is increased.

In yet a further embodiment, the conductive composition includes the conductive metal, a first resin component, and a second resin component that is reactive with the first resin component. The conductive metal is a described above and has the metal oxide and the lubricant present on its surface. Preferably, the conductive metal is silver flakes 11. The first resin component is equivalent to the resin component described above. As such, it is most preferred that the first resin component includes at least one of the hydroxy-functional resin and the amine-functional resin.

The second resin component is blocked at a first temperature and unblocked at a second temperature that is greater than the first temperature. That is, the second resin component becomes unblocked, or liberates, at an elevated temperature. Preferably, the first temperature is less than 80° C. and the second temperature ranges from 80 to 250° C.

The unblocking of the second resin component at the second temperature produces a first fluxing agent and a second fluxing agent. The first fluxing agent is reactive with at least the metal oxide, and maybe even with the lubricant. The second fluxing agent is reactive with at least the lubricant, and maybe even with the metal oxide. Once again, where the conductive metal is silver flakes 11, the lubricant can include silver stearates as stearic acid remaining from the processing of the silver flakes 11. The reactions of the first and second fluxing agents at least partially remove the metal oxide and the lubricant from the surface of the conductive metal thereby increasing a conductivity of the conductive composition. The first and second fluxing agents are produced, upon the unblocking of the second resin component, in sufficient quantity to effectively clean the conductive metal, i.e., the silver flakes 11, of impurities so that the silver flakes 11 come together in intimate contact and fuse to reduce the resistance of the conductive composition by at least 50%, which correspondingly improves the conductivity. The resistance of the conductive composition is less than or equal to 10 milliohms per square. It is also possible that the silver flakes 11 realize cold welding of a noble metal where the silver flakes 11 may weld and joint together.

In this particular embodiment, it is preferred that the second resin component includes a blocked isocyanate. However, it is to be understood to the second resin component may be other blocked chemical agents that are not isocyanates so long as it is reactive with the first resin component, blocked at the first temperature, and unblocked at the second temperature to produce the first and second fluxing agents as described above. If the second resin component is the blocked isocyanate, it is preferably blocked with the same blocking agents described above. That is, it is preferred that the blocked isocyanate is blocked with a blocking agent selected from the group consisting of e-caprolactam, methyl-ethyl ketoxime, di-ethyl malonate, di-methyl pyrazole, and combinations thereof.

In the embodiment where the second resin component is the blocked isocyanate, the unblocking of the blocked isocyanate produces an unblocked isocyanate as the first fluxing agent and a free blocking agent as the second fluxing agent. With many of the blocking agents set forth above, the free blocking agent produced upon the unblocking of the blocked isocyanate is an amine that functions as the second fluxing agent. As such, the unblocked isocyanate is reactive with at least the metal oxide, and possibly with the lubricant and the free blocking agent is reactive with at least the lubricant, and possibly with the metal oxide. The unblocked isocyanate and the free blocking agent essentially remove the metal oxide and the lubricant from the surface of the conductive metal, i.e., from the surface of the silver flakes 11, to increase the conductivity.

The present invention is still further embodied in the method of using the conductive composition. This method includes the step of depositing a trace 10 of the conductive composition on the substrate. As alluded to above, the trace 10 of the conductive composition can be deposited on a wide variety of substrates. If the substrate is a circuit board, the trace 10 is deposited on the circuit board. Alternatively, the trace 10 of the conductive composition may be deposited on the substrate to join electrical and electronic components into a circuit or may be deposited on the substrate to attach dies to lead frames in preparation of electrical and electronic components. However, the method of the subject invention is not limited to such applications.

The method further includes the step of heating the conductive composition to at least the second temperature, i.e., to at least 80° C., so as to cause the second resin component to unblock. More specifically, the conductive composition is preferably heated from 80 to 250° C., more preferably from 100 to 200° C., and most preferably from 180 to 200° C. Heating the conductive composition in these temperature ranges causes the second resin component to unblock, or dissociate, to produce the first and second fluxing agents. Of course, it is to be understood that the ideal temperature range may vary depending on the particular type and amount of the second resin component as well as the particular blocking agent associated with the second resin component.

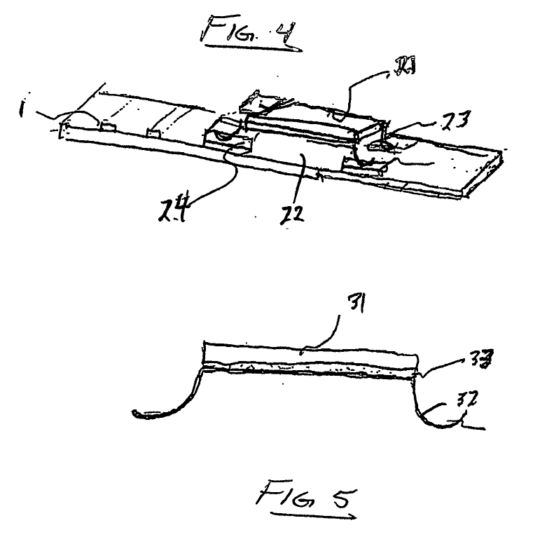

Upon heating, the first and second resin components react to cure and the first and second fluxing agents are produced to remove the metal oxide and the lubricant from the surface of the conductive metal thereby increasing the conductivity of the trace 10 of the conductive composition a described above. Overall, the first fluxing agent, typically an unblocked isocyanate, and the second fluxing agent, typically an amine-based compound, are very effective fluxing agents for the removal of any impurities—both metal oxides and lubricants—that are upon the surface of the conductive metal. Referring to FIGS. 2A and 2B, prior to heating, the trace 10 is initially un-sintered and the silver flakes 11 are generally separated. On the other hand, referring to FIGS. 3A and 3B, after heating, the trace 10 is sintered and the silver flakes 11 of the conductive composition and of the trace 10 come into closer, and improved, contact. This closer, improved contact improves the conductivity of the conductive composition and trace 10.

When the conductive composition is heated to the most preferred temperature range of from 180 to 200° C., two primary advantages are realized. First, the conductive composition will “snap cure”, providing very rapid processing. Second, the conductivity of the conductive composition will be significantly enhanced, becoming from two to ten times more conductive than compositions heated at in lower temperature ranges. The first and second resin components and the first and second fluxing agents are the same as those described above in greater detail.

Although it is not required, it is preferred that the conductive composition is heated to at least the second temperature by subjecting the conductive composition to microwave radiation with a suitable microwave oven. In the most preferred embodiment of the subject invention, the conductive composition is heated to at least the second temperature by subjecting the conductive composition to variable frequency microwave radiation. Energy waves from the variable frequency microwave radiation heat the conductive composition to the second temperature. If variable frequency microwave radiation is used to heat the conductive composition, then the conductive composition is typically subjected to this form of radiation for a time period of from 3 to 20 minutes.

The heating of the conductive composition of the subject invention beneficially affects the conductivity of the conductive composition, and the trace 10 of the conductive composition, because the heating causes the dissociation of the second resin component, which is blocked at the first temperature, to produce the first and second fluxing agents which react, or flux, with the metal oxide and the lubricant on the surface of the conductive metal as described above.

Furthermore, the heating of the conductive composition at the temperature set forth above, as well as according to the preferred variable frequency microwave radiation, does not adversely affect the substrate. The first and second resin components cure, the silver flakes 11 fuse and/or come into intimate contact with one another to improve conductivity, while the non-conductive substrate shows insignificant effects of any heating because the substrate is not heated by the variable frequency microwave radiation.

Referring now to FIGS. 4 and 5, certain applications for the conductive composition are illustrated. Referring to FIG. 4, the conductive composition is used as a die attachment adhesive. A component 21 is adhered to a substrate 22 by leads 23 that connect to pads 24. The pads 24 are made from the conductive composition, serving also as an adhesive, in accordance with the present invention. Referring to FIG. 5, the conductive composition is used to connect an electronic component die to lead frames. An electronic component 31 is physically and electrically connected to a lead frame 32 by operation of the conductive composition, serving also as an adhesive 33, in accordance with the present invention.

The following examples illustrating the conductive composition and the method of using the conductive composition, as presented herein, are intended to illustrate and not to limit the invention. All references to parts by weight in the present application are based on 100 parts by weight of the conductive composition.

Referring to the following table, the conductive composition was prepared by adding and reacting the following parts by weight (pbw). The pbw of each component outlined herein, especially the pbw of the conductive metal, the isocyanate component, and the resin component are important for optimum reaction to cure and for lower resistivity, i.e., enhanced conductivity.

| | Ex. 1 | Ex. 1 | Ex. 2 | Ex. 2 | Ex. 3 | Ex. 3 | Ex. 4 | Ex. 4 |
|---|---|---|---|---|---|---|---|---|
| Component | grams | pbw/100 | grams | pbw/100 | grams | pbw/100 | grams | pbw/100 |
| First | 7.50 | 2.08 | .34 | 2.86 | .49 | 3.33 | .43 | 3.21 |
| Resin | | | | | | | | |
| Component | | | | | | | | |
| Second | 30.00 | 8.33 | — | — | — | — | — | — |
| Resin | | | | | | | | |
| Component | | | | | | | | |
| #1 | | | | | | | | |
| Second | — | — | 1.00 | 8.40 | — | — | — | — |
| Resin | | | | | | | | |
| Component | | | | | | | | |
| #2 | | | | | | | | |
| Second | — | — | — | — | 1.00 | 6.80 | — | — |
| Resin | | | | | | | | |
| Component | | | | | | | | |
| #3 | | | | | | | | |
| Second | — | — | — | — | — | — | 1.00 | 7.46 |
| Resin | | | | | | | | |
| Component | | | | | | | | |
| #4 | | | | | | | | |
| Conductive | 300.00 | 83.33 | 9.52 | 80.00 | 11.76 | 80.00 | 10.70 | 79.85 |
| Metal | | | | | | | | |
| Solvent | 22.50 | 6.26 | 1.04 | 8.74 | 1.45 | 9.87 | 1.27 | 9.48 |

In the above table:

First Resin Component is PKHP-200 Solid Grade Phenoxy Resin (InChem Corp.);

Second Resin Component #1 is Bayhydur BL 116 (Bayer Corporation);

Second Resin Component #2 is Trixene® BI 7950 (Baxenden);

Second Resin Component #3 is Trixene® BI 7962 (Baxenden);

Second Resin Component #4 is Trixene® BI 7990 (Baxenden);

Conductive Metal is Silver Flake 52 (FerroMet); and

Solvent is butyl Cellosolve (Dow Chemical).

Examples 2-4 of the conductive composition were drawn down onto a glass substrate and first dried at 80° C. for 5 minutes as a pre-bake to flash off the solvent. Next, these Examples were cured at 180° C. for 5 minutes and compared to a drawdown of a Control Example that did not incorporate blocked isocyanate. The Control Example was first dried at 80° C. for 1 minute as a pre-bake to flash off the solvent and then cured at 180° C. for 5 minutes. The resistance and film build of the conductive composition was evaluated in order to effectively compare resistivity between Examples 2-4 and the Control Example. The results are summarized in the following table.

| | | | | | Resistivity | Resistivity |
|---|---|---|---|---|---|---|
| | | Heating | | Film | 25μ | 40μ |
| | Drying | & Curing | Resistivity | Build | normalized | normalized |
| Example | Conditions | Conditions | (ohms) | (microns) | (milliohms) | (milliohms) |
| 2 | 80° C. × 5 min. | 180° C. × 5 min. | .071 | 30 | 8.5 | 5.3 |
| 3 | 80° C. × 5 min. | 180° C. × 5 min. | .069 | 30 | 8.3 | 5.2 |
| 4 | 80° C. × 5 min. | 180° C. × 5 min. | .074 | 30 | 8.9 | 5.6 |
| Control | 80° C. × 1 min. | 180° C. × 5 min. | .148 | 30 | 17.8 | 11.1 |
| Example | | | | | | |

The data included in the above table establishes that the resistivity of the conductive compositions of the subject invention are generally on the order of 3 to 10 milliohms per square and that the normalized resistivities of the conductive compositions of Examples 2-4 are lower than the normalized resistivity of the Control Example by at least 50%. Of course, a corresponding effect on conductivity is also realized.

In separate Examples, the conductive composition of Example 1 was deposited on a high impact polystyrene (HIP) substrate and on a Kapton® (DuPont) polyimide film substrate in the form of a trace. Next, the conductive compositions and the respective substrates were heated by being subjected to variable frequency microwave (VFM) radiation to produce various straight line and serpentine traces. The results of this experimentation are summarized in the following tables.

| Type | | Heating | |
|---|---|---|---|
| Of | | & Curing | Resistivity |
| Substrate | Type of Trace | Conditions | (ohms) |
| HIP | Straight Line/ | VFM | 5.5 |
| | Narrow | 85° C. × 5 mins | |
| HIP | Straight Line/ | VFM | 3.2 |
| | Medium | 85° C. × 5 mins | |
| HIP | Straight Line/ | VFM | 1.4 |
| | Wide | 85° C. × 5 mins | |
| HIP | Serpentine/ | VFM | 1.9 |
| | Wide | 85° C. × 5 mins | |
| HIP | Straight Line/ | VFM | 5.0 |
| | Narrow | 90° C. × 10 mins | |
| HIP | Straight Line/ | VFM | 3.1 |
| | Medium | 90° C. × 10 mins | |
| HIP | Straight Line/ | VFM | 1.4 |
| | Narrow | 90° C. × 10 mins | |
| HIP | Serpentine/ | VFM | 4.7 |
| | Narrow | 90° C. × 10 mins | |
| HIP | Serpentine/ | VFM | 2.3 |
| | Wide | 90° C. × 10 mins | |
| HIP | Straight Line/ | VFM | 4.5 |
| | Narrow | 90° C. × 15 mins | |
| HIP | Straight Line/ | VFM | 2.8 |
| | Medium | 90° C. × 15 mins | |
| HIP | Straight Line/ | VFM | 1.2 |
| | Narrow | 90° C. × 15 mins | |
| HIP | Serpentine/ | VFM | 4.6 |
| | Narrow | 90° C. × 15 mins | |
| HIP | Serpentine/ | VFM | 2.2 |
| | Wide | 90° C. × 15 mins | |
| Kapton ® | Straight Line/ | VFM | 4.2 |
| | Narrow | 70° C. × 15 mins | |
| Kapton ® | Straight Line/ | VFM | 2.9 |
| | Medium | 70° C. × 15 mins | |
| kapton ® | Straight Line/ | VFM | 1.4 |
| | Wide | 70° C. × 15 mins | |
| kapton ® | Serpentine/ | VFM | 5.0 |
| | Narrow | 70° C. × 15 mins | |
| kapton ® | Serpentine/ | VFM | 1.9 |
| | Wide | 70° C. × 15 mins | |
| Kapton ® | Straight Line/ | VFM | 4.4 |
| | Narrow | 90° C. × 10 mins | |
| kapton ® | Straight Line/ | VFM | 2.7 |
| | Medium | 90° C. × 10 mins | |
| Kapton ® | Straight Line/ | VFM | 1.3 |
| | Wide | 90° C. × 10 mins | |
| kapton ® | Serpentine/ | VFM | 5.4 |
| | Narrow | 90° C. × 10 mins | |
| Kapton ® | Serpentine/ | VFM | 2.2 |
| | Wide | 90° C. × 10 mins | |
| kapton ® | Straight Line/ | VFM | 2.9 |
| | Narrow | 130° C. × 10 mins | |
| kapton ® | Straight Line/ | VFM | 2.1 |
| | Medium | 130° C. × 10 mins | |
| kapton ® | Straight Line/ | VFM | 1.1 |
| | Wide | 130° C. × 10 mins | |
| Kapton ® | Serpentine/ | VFM | 3.7 |
| | Narrow | 130° C. × 10 mins | |
| kapton ® | Serpentine/ | VFM | 1.6 |
| | Wide | 130° C. × 10 mins | |

In further Examples, the conductive composition of Example 1 was deposited on a bare FR4 board as a substrate to evaluate the heat and cure conditions necessary to achieve full cure of the conductive composition. To evaluate cure, three physical properties were observed:

(1) Volume Resistivity and Sheet Resistivity. Volume resistivity measure using a calibrated Keithley 2400 multimeter attached to a 4-pole probe. The conductive composition was applied in a 0.1″ wide by one 3M Scotch #600 transparent tape thickness (appx. 0.0013″). Sheet resistivity was determined by the 1″×0.1″ reading taken by the Keithley multimeter (10 squares).

(2) Adhesion/Tape Pull. 3M Scotch Tape #810 was used and an “X” was inscribed into the cured conductive composition, the tape is adhered over the inscribed “X” and the tape is then pulled away and subjectively observed for the amount of material pulled away with the tape.

(3) Solvent Resistance. Acetone was used. A small piece of cheesecloth is submersed in acetone. The piece of cheesecloth is then rubbed across the cured conductive composition. The amount of rubs are counted until the material is removed from the substrate. If the amount of rubs reaches 100 rubs, then this physical property test is stopped.

The results of this experimentation is summarized in the following table.

| Heating | Volume | Sheet | | | |
|---|---|---|---|---|---|
| & Curing | Resistivity | Resistivity | Adhesion/ | Solvent | |
| Conditions | (ohm-cm) | (milliohm/sq) | Tape Pull | Resistance | Comments |
| 100° C. × 10 min | 3.72E−05 | 11.0 | Poor | 3 | Heated/cured with |
| | | | | | hot plate |
| 130° C. × 10 min | 1.96E−05 | 6.3 | Poor | 25 | Heated/cured with |
| | | | | | hot plate |
| 130° C. × 20 min | 2.55E−05 | 7.2 | Poor | 25 | Heated/cured with |
| | | | | | oven |
| 130° C. × 30 min | 2.16E−05 | 6.0 | Poor | 90 | Heated/cured with |
| | | | | | oven |
| 130° C. × 60 min | 2.05E−05 | 6.6 | Good | >100 | Heated/cured with |
| | | | | | oven |
| 150° C. × 10 min | 1.95E−05 | 6.5 | Fair | >100 | Heated/cured with |
| | | | | | oven |
| 150° C. × 20 min | 2.04E−05 | 6.3 | Good | >100 | Heated/cured with |
| | | | | | oven |
| 180° C. × 5 min | 1.67E−05 | 5.2 | Good | >100 | Heated/cured with |
| | | | | | oven |

As alluded to above, the conductive composition of Example 1 incorporates, as the second resin component, Bayhydur BL 116 blocked isocyanate which does not unblock until approximately 130 to 140° C. Accordingly, as the date in the table above establishes, the conductive composition that was heated at 100° C.×10 minutes does not cure and, as a result, the sheet resistivity of this sample remains high.

Of course, it is to be understood that, if other isocyanates were selected for the second resin component, then the temperature at which the blocked isocyanate unblocks may vary. For instance, it is estimated that Trixene® BI 7950, which is blocked with DMP, unblocks at approximately 120° C. and Trixene® BI 7962, which is blocked with DEM, unblocks at approximately 80° C. Therefore, if Trixene® BI 7962 is selected, then a heating temperature of 100° C.×10 minutes may be sufficient to complete cure and enhance conductivity.

Obviously, many modifications and variations of the present invention are possible in light of the above teachings. The invention may be practiced otherwise than as specifically described within the scope of the appended claims.

In the claims:

1. A conductive composition comprising:
a conductive metal including a surface and present in an amount of from 40 to 95 parts by weight, wherein a metal oxide and a lubricant are present on said surface;
an isocyanate component present in an amount of from 2 to 20 parts by weight; and
a resin component reactive with said isocyanate component and present in an amount of from 1 to 20 parts by weight,
wherein all parts by weight are based on 100 parts by weight of said conductive composition, and wherein said isocyanate component is reactive with said metal oxide and said lubricant to at least partially remove said metal oxide and said lubricant from said surface of said conductive metal thereby increasing a conductivity of said conductive composition.

2. A conductive composition as set forth in claim 1 wherein said conductive metal is selected from the group consisting of copper, silver, aluminum, gold, platinum, palladium, beryllium, rhodium, nickel, zinc, cobalt, iron, molybdenum, iridium, rhenium, mercury, ruthenium, osmium, and combinations thereof.

3. A conductive composition as set forth in claim 1 wherein said conductive metal comprises a noble metal.

4. A conductive composition as set forth in claim 3 wherein said noble metal comprises silver in particle form.

5. A conductive composition as set forth in claim 1 wherein said isocyanate component comprises a blocked isocyanate.

6. A conductive composition as set forth in claim 5 wherein said blocked isocyanate comprises blocked hexamethylene diisocyanate.

7. A conductive composition as set forth in claim 5 wherein said blocked isocyanate is blocked with a blocking agent selected from the group consisting of e-caprolactam, methyl-ethyl ketoxime, di-ethyl malonate, di-methyl pyrazole, and combinations thereof.

8. A conductive composition as set forth in claim 7 wherein said blocked isocyanate becomes unblocked at temperatures of from 80 to 250° C. thereby forming an unblocked isocyanate and a free blocking agent.

9. A conductive composition as set forth in claim 8 wherein a metal oxide and a lubricant are present on a surface of said conductive metal and said unblocked isocyanate and said free blocking agent are reactive with said metal oxide and said lubricant to at least partially remove said metal oxide and said lubricant from said surface of said conductive metal thereby increasing said conductivity of said conductive composition.

10. Cancelled

11. A conductive composition as set forth in claim 1 wherein said resin component comprises a hydroxy-functional resin that reacts with said isocyanate component to form a polyurethane upon cure.

12. A conductive composition as set forth in claim 11 wherein said hydroxy-functional resin comprises a phenoxy resin.

13. A conductive composition as set forth in claim 11 wherein a ratio of NCO functional groups in said isocyanate component to OH function groups in said hydroxy-functional resin is from 1:1 to 1:2.

14. Cancelled

15. A conductive composition as set forth in claim 1 further comprising a solvent present in an amount of from 5 to 20 parts by weight for dissolving said isocyanate component and said resin component.

16. A conductive composition as set forth in claim 15 wherein said solvent is selected from the group consisting of ethylene glycol monobutyl ether, diethylene glycol monobutyl ether, and combinations thereof.

17. A conductive composition as set forth in claim 1 wherein said conductive metal is present in an amount of from 60 to 95 parts by weight.

18. A conductive composition as set forth in claim 1 wherein said isocyanate component is present in an amount of from 4 to 12 parts by weight.

19. A conductive composition as set forth in claim 1 wherein said resin component is present in an amount of from 2 to 10 parts by weight.

20. A conductive composition as set forth in claim 15 wherein said solvent is present in an amount of from 6 to 12 parts by weight.

21. A conductive composition as set forth in claim 1 having a resistance less than or equal to 10 milliohms per square.

22. A substrate having a conductive trace formed from said conductive composition of claim 1.

23. A conductive composition consisting essentially of:
a conductive metal including a surface and present in an amount of from 40 to 95 parts by weight, wherein a metal oxide and a lubricant are present on said surface;
an isocyanate component present in an amount of from 2 to 20 parts by weight;
a resin component reactive with said isocyanate component and present in an amount of from 1 to 20 parts by weight; and
a solvent present in an amount of from 5 to 20 parts by weight for dissolving said isocyanate component and said resin component,
wherein all parts by weight are based on 100 parts by weight of said conductive composition, and wherein said isocyanate component is reactive with said metal oxide and said lubricant to at least partially remove said metal oxide and said lubricant from said surface of said conductive metal thereby increasing a conductivity of said conductive composition.

24. Cancelled

25. A conductive composition comprising:
a conductive metal having a surface on which is present a metal oxide and a lubricant; and
a first resin component;
said conductive composition characterized by a second resin component reactive with said first resin component, wherein said second resin component is blocked at a first temperature and unblocked at a second temperature that is greater than said first temperature to produce;
a first fluxing agent, and
a second fluxing agent,
with said first fluxing agent reacting with at least said metal oxide and said second fluxing agent reacting with at least said lubricant to at least partially remove said metal oxide and said lubricant from said surface of said conductive metal thereby increasing a conductivity of said conductive composition.

26. A conductive composition as set forth in claim 25 wherein said second resin component comprises a blocked isocyanate.

27. A conductive composition as set forth in claim 26 wherein said blocked isocyanate is blocked with a blocking agent selected from the group consisting of e-caprolactam, methyl-ethyl ketoxime, di-ethyl malonate, di-methyl pyrazole, and combinations thereof.

28. A conductive composition as set forth in claim 26 wherein said blocked isocyanate, upon unblocking, produces an unblocked isocyanate as said first fluxing agent and a free blocking agent as said second fluxing agent.

29. A conductive composition as set forth in claim 26 wherein first resin component comprises at least one of a hydroxy-functional resin and an amine-functional resin.

30. A conductive composition as set forth in claim 25 wherein said first temperature is less than 80° C. and said second temperature ranges from 80 to 250° C.

31. A conductive composition as set forth in claim 25 having a resistance less than or equal to 10 milliohms per square.

32. A method of using a conductive composition, said method comprising the steps of:
depositing a trace of the conductive composition on a substrate, wherein the conductive composition comprises;
1) a conductive metal having a surface on which is present a metal oxide and a lubricant;
2) a first resin component; and
3) a second resin component reactive with the first resin component, wherein the second resin component is blocked at a first temperature and unblocked at a second temperature that is greater than the first temperature to produce;
3a) a first fluxing agent, and
3b) a second fluxing agent, with the first fluxing agent reacting with at least the metal oxide and the second fluxing agent reacting with at least the lubricant to at least partially remove the metal oxide and the lubricant from the surface of the conductive metal; and
heating the conductive composition to at least the second temperature so as to cause the second resin component to unblock such that the first and second resin components react to cure and such that the first and second fluxing agents are produced to remove the metal oxide and the lubricant from the surface of the conductive metal thereby increasing a conductivity of the trace of the conductive composition.

33. A method as set forth in claim 32 wherein said step of heating the conductive composition to at least the second temperature is further defined as subjecting the conductive composition to microwave radiation to heat the conductive composition to at least the second temperature.

34. A method as set forth in claim 33 wherein said step of subjecting the conductive composition to microwave radiation is further defined as subjecting the conductive composition to variable frequency microwave radiation.

35. A method as set forth in claim 34 wherein said step of subjecting the conductive composition to variable frequency microwave radiation is further defined as subjecting the conductive composition to variable frequency microwave radiation for a time period of from 3 to 20 minutes.

36. A method as set forth in claim 32 wherein the first temperature is less than 80° C. and the second temperature ranges from 80 to 250° C. such that said step of heating the conductive composition to at least the second temperature is further defined as heating the conductive composition to at least 80° C.

37. A method as set forth in claim 32 wherein the substrate is a circuit board and said step of depositing the trace of the conductive composition on the substrate is further defined as depositing a trace of the conductive composition on the circuit board.

38. A method as set forth in claim 32 wherein said step of depositing the trace of the conductive composition on the substrate is further defined as depositing a trace of the conductive composition on a substrate to join electrical and electronic components into a circuit.

39. A method as set forth in claim 32 wherein said step of depositing the trace of the conductive composition on the substrate is further defined as depositing a trace of the conductive composition on a substrate to attach dies to lead frames in preparation of electrical and electronic components.

40. A conductive composition comprising:
a conductive metal present in an amount of from 40 to 95 parts by weight;
an isocyanate component present in an amount of from 2 to 20 parts by weight; and
a resin component comprising an amine-functional resin reactive with said isocyanate component to form a polyurea upon cure, said resin component being present in an amount of from 1 to 20 parts by weight,
wherein all parts by weight are based on 100 parts by weight of said conductive composition.

41. A conductive composition as set forth in claim 40 wherein said conductive metal is selected from the group consisting of copper, silver, aluminum, gold, platinum, palladium, beryllium, rhodium, nickel, zinc, cobalt, iron, molybdenum, iridium, rhenium, mercury, ruthenium, osmium, and combinations thereof.

42. A conductive composition as set forth in claim 40 wherein said conductive metal comprises a noble metal.

43. A conductive composition as set forth in claim 40 wherein said isocyanate component comprises a blocked isocyanate.

44. A conductive composition as set forth in claim 40 wherein a metal oxide and a lubricant are present on a surface of said conductive metal and said isocyanate component is reactive with said metal oxide and said lubricant to at least partially remove said metal oxide and said lubricant from said surface of said conductive metal thereby increasing a conductivity of said conductive composition.

45. A conductive composition as set forth in claim 40 further comprising a solvent present in an amount of from 5 to 20 parts by weight for dissolving said isocyanate component and said resin component.

46. A conductive composition as set forth in claim 40 having a resistance less than or equal to 10 milliohms per square.

47. A substrate having a conductive trace formed from said conductive composition of claim 40.
